(19) United States
(12) Patent Application Publication
(10) Pub. No.: US 2025/0373020 A1
(43) Pub. Date: Dec. 4, 2025

(54) METHOD FOR CONTROLLING RENEWABLE ENERGY PARK

(71) Applicant: SUZLON ENERGY LIMITED, Gujarat (IN)

(72) Inventors: Venkata Rama Raju RUDRARAJU, Rostock (DE); Siddhant GURU, Pune (IN); Jens THIES, Rostock (DE)

(73) Assignee: SUZLON ENERGY LIMITED, Gujarat (IN)

(21) Appl. No.: 18/887,571

(22) Filed: Sep. 17, 2024

(30) Foreign Application Priority Data
May 31, 2024 (IN) 202321062609

(51) Int. Cl. H02J 3/38; H02J 3/00; H02J 13/00

(52) U.S. Cl. CPC H02J 3/38; H02J 3/00125; H02J 13/00002; H02J 13/00006; H02J 13/00034; H02J 2300/24; H02J 2300/28; H02J 2300/40

(57) ABSTRACT

Method control renewable energy parks having at least two renewable energy resources and comprise measuring a power output of renewable energy park at point of measurement, obtaining at least one required utility grid parameter at point of interconnection, determining an electrical power offset based on line losses between point of measurement and point of interconnection for compensating the line losses and for matching with required utility grid parameter, and adding electrical power offset to a control set point of the at least one renewable energy resource at a renewable energy park controller for controlling the at least one renewable energy resource.

This application claims the benefit of priority of Indian patent application Ser. No. 20/232,1062609, filed Sep. 18, 2023, the entire contents of which are incorporated herein by reference.

### FIELD OF DISCLOSURE

The present disclosure is directed to a method for controlling renewable energy park, a method for operating a renewable energy park, a renewable energy park controller for performing the method for controlling renewable energy park and a renewable energy park comprising the renewable energy park controller.

### BACKGROUND

It is known from prior art that power grids inside of renewable energy plants connect individual wind turbine generators of a wind power plant or photovoltaic generators of a solar farm to a point of common coupling (PoCC)—where all generated power is collected. The point of control (PoC) can be at this point of common coupling or at a remote Point of Interconnection (POI) where the wind or solar power feeds into the transmission lines. In order to control the power at Point of Interconnection (POI) the impedance of the power grid between PoCC of the wind and/or solar park and the Point of Interconnection (POI) has to be taken into consideration. Especially as the point of interconnection often is where the renewable energy park has to fulfill the requirement in the grid code, i.e. grid connection specification.

The impedance of the power lines connecting PoCC of the renewable energy park to the POI causes non-linear relation between power at PoCC and POI, as the power lines supply reactive power when lightly loaded and absorb reactive power when fully loaded.

Wind and solar power parks are often controlled by a park controller connected at PoCC where the measurement of electrical parameters is done. The park controller controls and communicates with the wind turbines and other components in the wind power park or with the solar generator in PV parks. In order to control the wind turbines or solar generators some measured electrical parameters are needed. The power park controller and the measurement sensors may be located remotely from the point of interconnection (POI), where the control applies, so due to the impedance in the grid the controlled parameters are not the same at the point of measurement at PoCC and the point of interconnection. It may be seen as an object of the embodiments of the present disclosure to provide a power plant controller that ensures proper values of electrical parameters in a point different from the point of measurement and even to have a smooth control transfer and stable operation in case of communication failures between power meter at POI and power plant controller.

Typically measurement and control of grid parameter of renewable energy resources such as wind parks or solar parks is accomplished by a renewable energy park controller at the pooling substation at PoCC where a number of individual units are electrically connected and jointly controlled by the renewable energy park controller. Typically pooling substation at PoCC is situated at remote locations with long connecting high voltage (HV) or medium voltage (MV) lines to a point of interconnection (POI) to the transmissions grid. According to IEV 601-01-28 the boundaries between medium-and high-voltage levels overlap and depend on local circumstances and history or common usage. Nevertheless the band 30 kV to 100 kV frequently contains the accepted boundary between medium and high voltage.

A transmission system operator demands control of voltage and frequency at point of interconnection (POI) where grid parameter need to be maintained within a limited, defined range to ensure continuous stable and balanced operation of renewable energy resources and utility grid.

### OBJECT OF THE DISCLOSURE

Line losses along the connecting high voltage (HV) or medium voltage (MV) lines between pooling substation at PoCC and point of interconnection vary with actual power generation, line parameters and other conditions. This leads to different voltages at pooling substation and point of interconnection. Further the voltage deviation is not constant; it varies with generation and other conditions. To keep the grid in stable operating conditions the voltage needs to be maintained at a desired level at point of interconnection through reactive power control.

There are two disadvantages with the prior art:
1. In many cases a direct measurement at point of interconnection is not available or cannot be accessed for various reasons.
2. Even if a measurement at point of interconnection is available, a fallback solution for communication delays or interruptions due to network faults is required for smooth control transfer and stable operation of power grid.

It is an object of the present disclosure to overcome these disadvantages.

### SUMMARY OF THE DISCLOSURE

An aspect of the present disclosure to solve the above-mentioned object is directed to a method for controlling renewable energy park comprising at least two renewable energy resources. The method comprises the steps of:
measuring a power output of renewable energy park at point of measurement,
obtaining at least one required utility grid parameter at point of inter-connection,
determining electrical power offset based on line losses between point of measurement and point of interconnection for compensating the line losses and for matching with required utility grid parameter, and
adding an electrical power offset to a control set point of the at least one renewable energy resource at a renewable energy park controller for controlling the at least one renewable energy resource.

This method overcomes the disadvantages of the prior art without adding additional hardware. At the same time grid code compliance of the renewable energy park is provided at point of interconnection. This method can be applied in new installed renewable energy parks as well as in existing ones without the need to install additional equipment. Furthermore this method gives an opportunity for a smooth fallback control and stable operation in renewable energy parks with metering at point of interconnection when the network communication fails. When measuring a power output of renewable energy park at POI, using the calculated offset during fallback mode to ensure smooth transfer of control and stable operation of control.

According to a preferred embodiment of the method for controlling renewable energy park comprising at least two renewable energy resources, the method further comprises the step of calculating line losses based on measurement and at least one line parameter of a high voltage (HV) or middle voltage (MV) line connecting pooling substation and POI.

According to a more preferred embodiment of the method of controlling renewable energy park the at least one line parameter for calculating line losses is resistance, impedance, susceptance or length or a combination thereof. Advantageously, for calculating line losses the line parameters resistance, impedance, susceptance and length will be used.

According to a preferred embodiment of the method of controlling renewable energy park, electrical power is active power and/or reactive power.

According to a preferred embodiment of the method of controlling a renewable energy park; the method further comprises the step of calculating the at least one grid parameter at point of interconnection.

According to a preferred embodiment of the method of controlling a renewable energy park; wherein the at least one grid parameter comprises grid voltage at point of interconnection (POI), power factor at point of interconnection (POI) and/or reactive power at point of interconnection (POI).

Another aspect is directed to a renewable energy park controller for performing said method for controlling the renewable energy park. The renewable energy park controller comprises a measuring unit for measuring a power output of the renewable energy park at the point of measurement, an obtaining unit for obtaining at least one required utility grid parameter at the point of interconnection, a determination unit for determining an electrical power offset based on line losses between the point of measurement and the point of interconnection for compensating the line losses and for matching with required utility grid parameter, and a summation unit for adding the electrical power offset to a control set point of the at least one renewable energy resource at a renewable energy park controller for controlling the at least one renewable energy source.

According to a preferred embodiment of the renewable energy park controller, the controller is a renewable energy park controller connected to each of the renewable energy resources.

Another aspect of the present disclosure is directed to a method for operating a renewable energy park comprising said renewable energy park controller performing the method for controlling renewable energy park.

According to a preferred embodiment of the method for operating a renewable energy park, the method further comprises the step of operating at least one of the renewable energy resources with power offset to compensate line losses.

According to a more preferred embodiment of the method for operating a renewable energy park, wherein operating at least one of the renewable energy resources with reactive power offset.

Another aspect of the present disclosure is directed to a renewable energy park. This comprises said renewable energy park controller and at least two renewable energy resources.

According to a preferred embodiment of the renewable energy park, this comprises at least one wind turbine park having at least one wind turbine, photovoltaic park having at least one photovoltaic device, biomass park having at least one biomass device or hydro park having at least one hydro device or a combination thereof as renewable energy resource.

Another aspect of the present disclosure is directed to a computer program product which comprises instructions which, when the program is executed by a computer, cause the computer to carry out the steps of said method for controlling renewable energy park.

The present disclosure serves several advantages, namely:
Stabilized grid voltage at point of interconnection to ensure grid code compliance of renewable energy generating park where control is requested by transmission system operator;
No need for additional equipment which saves costs;
Can be updated in any existing renewable energy park;
Fast, real time measurement with built-in power meter at pooling substation are used for offset calculations, no additional network connection required;
Does not require a back-up procedure for disturbed connection to point of interconnection meter;
Can form a back-up for safe, smooth transfer of control at point of interconnection without having access to measurement devices at point of interconnection;
Possible increase in revenue by stabilized generation thus reducing the need for curtailment or generation stop;
Possible increased generation by avoiding or reducing precautionary wind farm curtailments due to lack of metering at point of interconnection in existing wind or solar farms.

### BRIEF DESCRIPTION OF DRAWINGS

The disclosure will now be explained in more detail with respect to exemplary embodiments with reference to the enclosed drawings, wherein:

FIG. 1 shows a known wind turbine (prior art);

FIG. 2 shows a renewable energy park comprising a plurality wind turbines, in an embodiment of the present disclosure;

FIG. 3 shows a hybrid renewable energy park comprising different energy resources, in an embodiment of the present disclosure; and

FIG. 4 shows a flow diagram of the method according to the present disclosure.

The foregoing and other aspects will become apparent from the following detailed description of the disclosure when considered in conjunction with the accompanying drawing figures.

### DETAILED DESCRIPTION OF THE DISCLOSURE

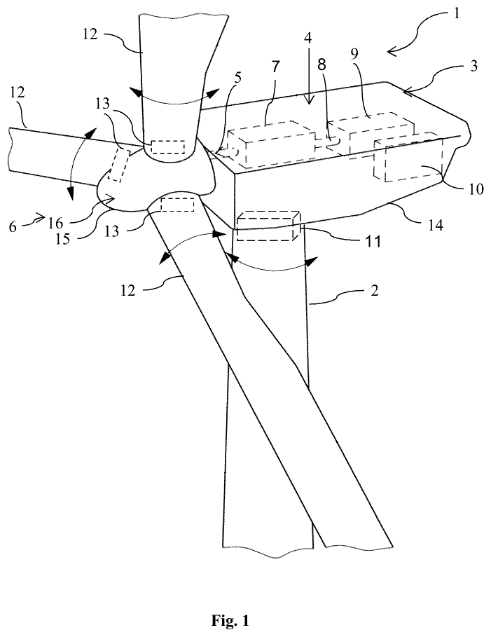

FIG. 1 depicts a schematic view of a wind turbine 1 with a tower 2 and a nacelle 3. Depending on given requirements the wind turbine 1 can be used for offshore or onshore applications. The nacelle 3 is rotatable mounted on the tower 2 which is indicated by a double arrow at the tower 2. The nacelle 3 incorporates a number of components like a drive train chain 4 comprising a rotor shaft 5 (also known as slow-speed-shaft) connecting a rotor 6 with a gear box 7. A high-speed-shaft 8 connects the gear box 7 with a generator 9. The generator 9 is connected with a plurality of electrical components indicated by box 10. Further the nacelle 3 comprises a yaw system 11 for rotating the nacelle 3 indicated by double arrow at tower 2. The rotor 6 comprises three rotor blades 12 which are mounted to a hub body (not shown). Latter is connected to the rotor shaft 5 of the drive train chain 4. The rotor blades 12 are adjustably mounted on the hub body indicated by double arrows at the rotor blade 12. This is realized by means of pitch drives 13, said pitch drives (not shown) being part of a pitch system 13. The pitch system controls the rotor speed to given set points. By means of pitch-drives, the rotor blades 12 may be moved about a rotor blade axes into different pitch positions which is indicated by double arrows at the rotor blade 13. Said rotor blade 6 axis extends in an axial direction of the rotor blades 13. Each rotor blade 13 is connected to the hub body via its blade bearing (not shown). The nacelle 3 is covered by a nacelle cover 14. The hub body is covered by a spinner 15, wherein the hub body and spinner 11 forming a hub 16.

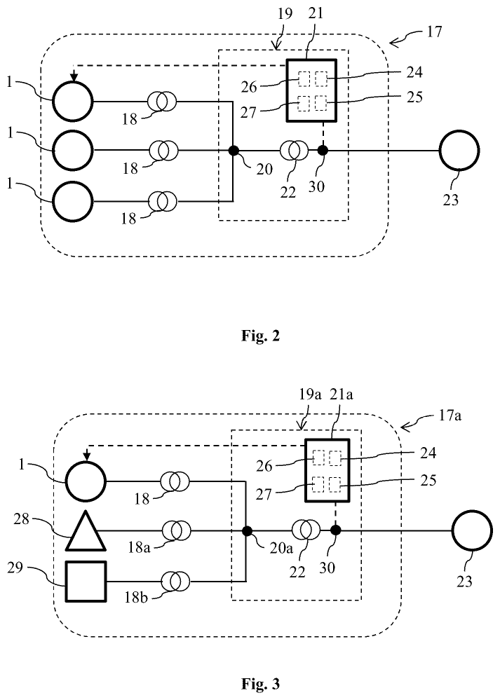

FIG. 2 depicts a renewable energy park 17 comprising a plurality wind turbines 1. Each wind turbine 1 is electrically connected via an associated transformer 18 to a pooling substation 19. Latter comprises a connection point 20 for connecting power output of all wind turbines 1 and a renewable energy park controller 21. The pooling substation 19 further comprises a transformer 22 at PoCC, and a point of measurement 30 is preferably at the high voltage side, but can also be at the low voltage side and is in signal connection with the renewable energy park controller 21. The renewable energy park controller 21 measures the combined generation of all wind turbines 1 at PoCC, and is controllably connected to each wind turbine 1. Further the transformer 22 is electrically connected to a point of interconnection 23. In context of this disclosure the point of interconnection 23 is the point where the transmission system operator overtakes the control of electrical parameters.

Between the point of measurement 30 and point of interconnection can be a distance up to several hundred kilometres. This leads to the disadvantages that in many cases a direct measurement at point of interconnection is not available or cannot be accessed for various reasons. Even if a measurement at point of interconnection is available, there might be communication failures/delays.

Facing this challenge the inventors came to the conclusion if transmission line impedance between the point of measurement 30 and point of interconnection 23 is known then the renewable energy park 17 can be operated with a power offset to compensate line losses caused by transmission line impedance.

For this the renewable energy park controller 21 comprises a measuring unit 24 which continuously measures the power output of renewable energy park 17 at point of measurement 30, an obtaining unit 25 which obtains at least one required utility grid parameter at point of interconnection 23, a determination unit 26 which determines electrical power offset based on line losses between point of measurement 30 and point of interconnection 23 for compensating the line losses and for matching with required utility grid parameter, and summation unit 27 which provides electrical power offset to a control set point of the at least one wind turbine 1 at a renewable energy park controller 21 for controlling the at least one wind turbine 1.

The measuring unit 24 measures the power output as well as electrical parameters like voltage and/or current of the renewable energy park 17. By obtaining via the obtaining unit 25 at least one line parameter of a high voltage (HV) or middle voltage (MV), like resistance, impedance, susceptance or a combination thereof the calculation of line losses can be executed. Latter based on measured electrical parameters like voltage or current or a combination thereof of the renewable energy park 17 and at least one obtained line parameter of a high voltage (HV) or middle voltage (MV) line connecting to the pooling substation 19. Furthermore the length between the point of measurement 30 and the point of interconnection 23 will be considered to calculate line losses. With these line losses together with the measured power output of the renewable energy park 17 the provided power at the point of interconnection 23 can be calculated. This calculated power output at point of interconnection 23 can be compared with the required power output at the point of interconnection 23 for the utility grid. The electrical power output is active power and reactive power. The difference between calculated and required power output determines the electrical power offset via the determination unit 26. At the summation unit 27 the electrical power offset will be added to the electrical power setpoint of at least one wind turbine 1. The electrical power offset and number of wind turbines 1 depends on the difference between provided and required power output at the point of interconnection 23. The bigger the difference is the bigger is the required electrical power offset. The electrical power offset can be provided by increasing number of wind turbines 1 with higher power output.

In the following, based on FIG. 3 it should be explained a further embodiment of the present disclosure. Components described before which have the same functions, but differs under constructions, are numbered with an “a”.

FIG. 3 depicts a hybrid energy park 17a comprising at least one wind turbine 1, at least one photovoltaic device 28 and at least one biomass device 29 or any other electric energy resource. Each wind turbine 1 is electrically connected via an associated transformer 18 to a pooling substation 19a. Each photovoltaic device 28 is electrically connected via an associated transformer 18a to a hybrid pooling substation 19a. Each biomass device 29 is electrically connected via an associated transformer 18b to a pooling substation 19a. Latter comprises a hybrid connection point 20a for connecting power output of all wind turbines 1, all photovoltaic devices 28 and all biomass devices 29 and a hybrid park controller 21a. The hybrid pooling substation 19a further comprises a transformer 22 and a point of measurement 30. Latter is preferably arranged at the high voltage side, but can also be at the low voltage side, and is in signal connection with the hybrid park controller 21a, which is also controllably connected to each wind turbine 1, each photovoltaic device 28 and biomass device 29. Further the transformer 22 is electrically connected to a point of interconnection 23. In context of this disclosure the point of interconnection 23 is the point where the transmission system operator overtakes the control of electrical parameters.

Between the point of measurement 30 and point of interconnection can be a distance of up to several hundred kilometres. This leads to the disadvantages that in many cases a direct measurement at point of interconnection is not available or cannot be accessed for various reasons. Even if a measurement at point of interconnection is available, there might be communication failures/delays.

Facing this challenge the inventors come to the conclusion if transmission line impedance between the point of measurement 30 and point of interconnection 23 is known then the hybrid energy park 17a can be operated with a power offset to compensate line losses caused by transmission line impedance.

For this the hybrid energy park controller 21a comprises a measuring unit 24 which measures the power output of a hybrid energy park 17a at the point of measurement 30, an obtaining unit 25 which obtains at least one required utility grid parameter at the point of interconnection 23, a determination unit 26 which determines the electrical power offset based on line losses between the point of measurement 30 and the point of interconnection 23 for compensating the line losses and for matching with required utility grid parameter, and a summation unit 27 which provides an electrical power offset to a control set point of the at least one wind turbine 1, to the at least one photovoltaic device 28 and/or to the at least one biomass device 29 at the hybrid park controller 21a.

The measuring unit 24 measures the power output as well as electrical parameters like voltage and/or current of the hybrid energy park 17a. By obtaining via the obtaining unit 25 at least one line parameter of a high voltage (HV) or middle voltage (MV), like resistance, impedance, susceptance or a combination thereof the calculation of line losses can be executed. Latter based on measured electrical parameters like voltage or current or a combination thereof of the hybrid energy park 17a and at least one obtained line parameter of a high voltage (HV) or middle voltage (MV) line connecting to the hybrid pooling substation 19a. Furthermore the length between the point of measurement 30 and the point of interconnection 23 will be considered to calculate line losses. With these line losses together with the measured power output of the hybrid energy park 17a the provided power at the point of interconnection 23 can be calculated. This calculated power output at the point of interconnection 23 can be compared with the required power output at the point of interconnection 23 for the utility grid. The electrical power output is active power and reactive power. The difference between calculated and required power output determines the electrical power offset via the determination unit 26. At the summation unit 27 the electrical power offset will be added to the electrical power setpoint of at least one wind turbine 1, at least one photovoltaic device 28 and/or biomass device 29. The electrical power offset and number of wind turbines 1, photovoltaic devices 28 and/or biomass devices 29 depends on the difference between provided and required power output at the point of interconnection 23. The bigger the difference is the bigger is the electrical power offset and the number of wind turbines 1, photovoltaic devices 28 and/or biomass devices 29 with higher power output.

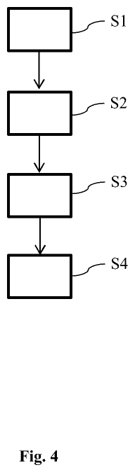

FIG. 4 depicts a flow diagram of method for controlling renewable energy park 17, 17a comprising at least two renewable energy resources 1, 28, 29. The method according to the present disclosure works for the renewable energy park 17 or the hybrid energy park 17a in same way. This method also works for controlling a hybrid power plant comprising of at least two different types of power plants including a renewable-energy park having at least one wind turbine 1 and a renewable-energy park having at least one photovoltaic device 28.

In general the in following described method works for renewable energy parks as well as for hybrid energy parks which are also under the scope of protection of the present disclosure. The method will be described with embodiment of a renewable energy park 17, but the same works in same way for a hybrid energy park 17a. The method comprises the steps S1 to S4 for controlling renewable energy park comprising at least two renewable energy resources.

Step S1 comprises measuring a power output of renewable energy park 17 at point of measurement 30. The measuring unit 24 of the renewable energy park controller 21 measures the power output as well as electrical parameters like voltage and/or current of the renewable energy park 17.

Step S2 comprises obtaining at least one required utility grid parameter at point of interconnection 23. The at least one line parameter is resistance, impedance, susceptance or length or a combination thereof. By obtaining via the obtaining unit 25 at least one line parameter of a high voltage (HV) or middle voltage (MV), like resistance, impedance, susceptance or a combination thereof the calculation of line losses can be executed. The calculation of line losses based on measurement and at least one line parameter of a high voltage (HV) or middle voltage (MV) line connecting to the pooling substation 19. Electrical power is active power and/or reactive power. Based on measured electrical parameters like voltage or current or a combination thereof of the renewable energy park 17 and at least one obtained line parameter of a high voltage (HV) or middle voltage (MV) line connecting to the pooling substation 19. Furthermore the length between the point of measurement 30 and the point of interconnection 23 will be considered to calculate line losses. With these line losses together with the measured power output of the renewable energy park 17 the provided power at the point of interconnection 23 can be calculated.

Step S3 comprises determining an electrical power offset based on line losses between point of measurement 30 and point of interconnection 23 for compensating the line losses and for matching with required utility grid parameter. The calculated power output of Step S2 at the point of interconnection 23 can be compared with the required power output at the point of interconnection 23 for the utility grid. The difference between calculated and required power output determines the electrical power offset via the determination unit 26.

Step S4 comprises adding electrical power offset to a control set point of at least one wind turbine 1 at a renewable energy park controller 21 for controlling the at least one renewable energy resource. At the summation unit 27 the electrical power offset will be added to the electrical power setpoint of at least one wind turbine 1. The electrical power offset depends on the difference between provided and required power output at the point of inter-connection 23. The bigger the difference is the bigger is the electrical power offset and the number of wind turbines 1 with higher power output.

Another aspect of the present disclosure is directed to a method of operating a renewable energy park 17, wherein the renewable energy park controller 21 is configured to perform the method for controlling renewable energy park 17 as described above. The method of operating a renewable energy park 17 comprises the step of operating at least one of the wind turbines 1 with electrical power offset to compensate line losses. The electrical power offset for the at least one wind turbine 1 is a reactive power offset. Same applies for the hybrid energy park 17a having a hybrid park controller 21a which is configured to perform the method for controlling hybrid energy park 17a as described above.

The above mentioned method can be executed by a computer program product comprising instructions which, when the program is executed by a computer, cause the computer to carry out the steps of the method for controlling renewable energy park described above.

LIST OF REFERENCE SIGNS

| | |
|---|---|
| 1 | wind turbine |
| 2 | tower |
| 3 | nacelle |
| 4 | drive train chain |
| 5 | rotor shaft |
| 6 | rotor |
| 7 | gear box |
| 8 | high-speed-shaft |
| 9 | generator |
| 10 | electrical components |
| 11 | yaw system |
| 12 | rotor blades |
| 13 | pitch system |
| 14 | nacelle cover |
| 15 | spinner |
| 16 | hub |
| 17 | renewable energy park |
| 17a | hybrid energy park |
| 18 | transformer |
| 19 | pooling substation |
| 19a | hybrid pooling substation |
| 20 | connection point |
| 20a | hybrid connection point |
| 21 | renewable energy park controller |
| 21a | hybrid park controller |
| 22 | transformer |
| 23 | point of interconnection |
| 24 | measuring unit |
| 25 | obtaining unit |
| 26 | determination unit |
| 27 | summation unit |
| 28 | photovoltaic device |
| 29 | biomass device |
| 30 | point of measurement |

We claim:

1. A method for controlling at least one renewable energy park comprising of at least two renewable energy resources, the method comprising:
measuring a power output of at least one renewable energy park at a point of measurement;
obtaining at least one required utility grid parameter at a point of interconnection;
determining an electrical power offset based on line losses between the point of measurement and the point of interconnection for compensating the line losses and for matching with the at least one required utility grid parameter; and
adding an electrical power offset to a control set point of at least one renewable energy resource at a renewable energy park controller for controlling the at least one renewable energy resource.

2. The method of claim 1, further comprising:
calculating line losses based on at least one measurement and at least one line parameter of a high voltage or middle voltage line connecting to at least one pooling substation.

3. The method of claim 2, wherein the at least one line parameter is resistance, impedance, susceptance, length, or a combination thereof.

4. The method of claim 1, wherein electrical power is active power and/or reactive power.

5. The method of claim 1, further comprising:
calculating the at least one grid parameter at the point of interconnection.

6. The method of claim 1, wherein the at least one grid parameter comprises grid voltage at the point of interconnection, power factor at the point of interconnection, reactive power at the point of interconnection, or a combination thereof.

7. A renewable energy park controller for performing the method of claim 1, the renewable energy park controller comprising:
a measuring unit for measuring a power output of renewable energy park at the point of measurement;
an obtaining unit for obtaining at least one required utility grid parameter at the point of interconnection;
a determination unit for determining electrical power offset based on line losses between the point of measurement and the point of interconnection for compensating the line losses and for matching with the at least one required utility grid parameter; and
a summation unit for adding electrical power offset to a control set point of the at least one renewable energy resource.

8. The renewable energy park controller of claim 7, wherein the renewable energy park controller is connected to each of the at least two renewable energy resources.

9. A method for operating at least one renewable energy park comprising the renewable energy park controller of claim 7.

10. The method of claim 9, comprising:
operating at least one of the renewable energy resources with power offset to compensate line losses.

11. The method of claim 10, wherein the at least one of the renewable energy resources is operated with reactive power offset.

12. A renewable energy park comprising:
the renewable energy park controller of claim 7; and
at least two renewable energy resources.

13. The renewable energy park of claim 12, further comprising:
at least one wind turbine park having at least one wind turbine;
at least one photovoltaic park having at least one photovoltaic device;
at least one biomass park having at least one biomass device;
at least one hydro park having at least one hydro device; or
a combination thereof as renewable energy resource.

14. A computer program product comprising instructions wherein, when the computer program is executed by a computer, causes the computer to carry out the method of claim 1.
